(19) United States
(12) Patent Application Publication
(10) Pub. No.: US 2026/0095605 A1
(43) Pub. Date: Apr. 2, 2026

(54) METHOD AND SYSTEM FOR EMBEDDING CUSTOM METADATA IN OTT STREAMING MANIFESTS

(71) Applicant: ZEE ENTERTAINMENT ENTERPRISES LIMITED, Mumbai (IN)

(72) Inventors: Rahul Banerjee, Howrah (IN); Suneel Khare, Bangalore (IN)

(73) Assignee: ZEE ENTERTAINMENT ENTERPRISES LIMITED, Mumbai (IN)

(21) Appl. No.: 19/046,902

(22) Filed: Feb. 6, 2025

(30) Foreign Application Priority Data
Oct. 2, 2024 (IN) 202421074526

(51) Int. Cl. H04N 21/238; H04N 21/234; H04N 21/235; H04N 21/845

(52) U.S. Cl. CPC H04N 21/23805; H04N 21/234; H04N 21/2353; H04N 21/8456

(57) ABSTRACT

The present invention provides a system (100) and method (200) for embedding custom metadata in Over-The-Top (OTT) streaming manifests to enhance the user experience. The system (100) includes an encoder and packager module (108) configured to generate Adaptive Bitrate (ABR) segments and corresponding media manifests. A manifest updater (112) embeds custom metadata within the manifests, including playback control information such as content advisories, scene-specific annotations, and interactive elements. The custom metadata is embedded as XML elements for DASH and UTF-8 tags for HLS, encoded in base64-encoded JSON format. The media manifests with embedded metadata are transmitted to a Content Delivery Network (CDN) (104), which delivers them to client devices (106). The client devices (106) may process the custom metadata or continue streaming without interruption if the metadata is not recognized, ensuring backward compatibility. The method (200) facilitates seamless integration of metadata, enhancing playback without affecting legacy systems.

### FIELD OF THE INVENTION

The present invention relates generally to the field of Over-The-Top (OTT) streaming technologies. More particularly, the present invention relates to a system and method for embedding custom metadata within streaming manifests.

### BACKGROUND OF THE INVENTION

The exponential growth of Over-The-Top (OTT) streaming platforms has transformed the way multimedia content is consumed globally. Modern OTT systems deliver high-quality audio and video content to users across diverse devices, using Adaptive Bitrate (ABR) streaming to provide seamless playback experiences. These systems often utilize Content Delivery Networks (CDNs) to efficiently distribute content, optimizing for latency and load balancing. However, as content delivery becomes increasingly dynamic, there is a growing demand for embedding scene-specific metadata within streaming manifests to enrich user experiences and comply with various regulatory requirements. For instance, metadata may be needed to insert real-time advertisements, display content advisories, or manage interactive content features that require contextual awareness during playback.

Despite the advantages, integrating such metadata into existing OTT streaming workflows presents substantial technical challenges. Conventional methods of metadata integration often rely on custom, non-standardized implementations, resulting in inconsistencies in how metadata is handled across various platforms and devices. Furthermore, current approaches typically embed metadata directly within the streaming content, creating rigid systems that are difficult to adapt to changing content delivery requirements. Consequently, modifying the metadata often requires regenerating entire manifests, leading to increased latency and delays in content availability. Additionally, many OTT platforms struggle with the efficient handling and dissemination of metadata.

The existing systems usually lack mechanisms to ensure that the metadata remains synchronized with the streaming content across various network conditions and playback scenarios. This desynchronization can cause playback inconsistencies, where the metadata might not align correctly with the intended segments of the media, thus impacting user experience. Furthermore, OTT platforms often face difficulties in ensuring backward compatibility of metadata with legacy systems, which complicates the introduction of new metadata-driven features. The ability to maintain compatibility with older client devices that may not support the latest metadata standards is critical, as it ensures uninterrupted playback for all users, regardless of the version or capability of their playback devices. Without backward compatibility, new metadata features may lead to playback failures or degraded user experiences on legacy systems, effectively limiting the adoption of innovative content features.

In light of these technical challenges, there is a need for an improved system and method that offers a technical solution to facilitate the seamless integration, management, and delivery of scene-specific metadata in OTT streaming platforms, while ensuring backward compatibility so that client devices not supporting the new metadata can continue functioning without disruption.

### OBJECTS OF THE INVENTION

Some of the objects of the present disclosure, which at least one embodiment herein satisfies are as follows:

It is an objective of the present disclosure to overcome one or more problems of the prior art or at least provide with a technical and useful alternative.

An objective of the present disclosure is to provide a system and a method to facilitate the seamless integration, management, and delivery of scene-specific metadata in OTT streaming platforms.

Another objective of the present disclosure is to provide a system and method for backward compatibility so that client devices not supporting the new metadata can continue functioning without disruption.

### SUMMARY OF THE INVENTION

In an embodiment of the present invention, a system for embedding custom metadata in Over-The-Top (OTT) streaming manifests is provided. The system comprises an encoder and packager module configured to generate Adaptive Bitrate (ABR) segments and corresponding media manifests for streaming media. The media manifest includes instructions for retrieving one or more media segments associated with the streaming media. The encoder and packager module can generate the media manifest according to at least one of: Dynamic Adaptive Streaming over HTTP (DASH) protocol and Hypertext Transfer Protocol Live Streaming (HLS) protocol.

The system further comprises a manifest updater that embeds custom metadata within the media manifest, which is configured to provide additional playback control information. For the DASH protocol, the manifest updater embeds the custom metadata as a new Extensible Markup Language (XML) element in a Media Presentation Description (MPD) file. For the HLS protocol, the manifest updater embeds the custom metadata as a custom 8-bit Unicode Transformation Format (UTF-8) tag in an M3U8 playlist.

The system also includes a storage module configured to store the generated ABR segments and media manifests with the embedded custom metadata. The custom metadata is encoded in a base64-encoded JavaScript Object Notation (JSON) format to facilitate flexible, extensible and compact representation of metadata fields.

Further, the Content Delivery Network (CDN) is configured to deliver the media manifest and the associated ABR segments to one or more client devices. The media manifest is transmitted through an adaptive bitrate streaming protocol to optimize playback quality based on real-time network conditions.

Furthermore, the client devices are configured to process the custom metadata to enhance the streaming experience and are operable to continue playback of the streaming media without processing the embedded custom metadata. The custom metadata comprises information for controlling playback features, such as content advisories, scene-specific annotations, in-scene advertisements, user-specific content settings, and interactive elements.

In another embodiment of the present invention, a method for embedding custom metadata in OTT streaming manifests. The method comprises generating a media manifest for streaming media, where the media manifest includes instructions for retrieving one or more media segments associated with the streaming media. The method further comprises embedding custom metadata within the media manifest, wherein the custom metadata is configured to provide additional playback control information.

The streaming media is generated in accordance with at least one of: DASH protocol and HLS protocol. For the DASH protocol, the custom metadata is embedded as a new XML element in a Media Presentation Description (MPD) file. For the HLS protocol, the custom metadata is embedded as a custom UTF-8 tag in an M3U8 playlist.

The method also includes transmitting the media manifest with the embedded custom metadata to a CDN, which is configured to deliver the media manifest to one or more client devices. The custom metadata can be encoded in a base64-encoded JSON format to facilitate flexible, extensible and standardized representation of metadata.

Further, the media manifest may be transmitted via an adaptive bitrate streaming (ABR) protocol to optimize playback quality based on real-time network conditions. The client device processes the custom metadata to enhance the streaming experience but is operable to continue playback of the streaming media without processing the embedded custom metadata, ensuring backward compatibility. The custom metadata comprises information for controlling playback features, including content advisories, scene-specific annotations, in-scene advertisements, user-specific content settings, and interactive elements.

### BRIEF DESCRIPTION OF THE DRAWINGS

The present invention is described by way of embodiments illustrated in the accompanying drawings wherein:

FIG. 1 is a block diagram illustrating a system for embedding custom metadata within streaming manifests in accordance with an embodiment of the present invention; and

FIG. 2 is a flowchart illustrating a method for embedding custom metadata within streaming manifests in accordance with an embodiment of the present invention.

### DETAILED DESCRIPTION OF THE INVENTION

The following disclosure is provided to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used are for the purpose of describing exemplary embodiments and should not be considered limiting. Thus, the present invention is to be accorded the widest scope encompassing numerous alternatives, modifications, and equivalents consistent with the principles and features disclosed. For clarity, details relating to technical material that is known in the technical fields related to the invention have not been described in detail so as not to unnecessarily obscure the present invention.

The present invention would now be discussed in the context of embodiments as illustrated in the accompanying drawings.

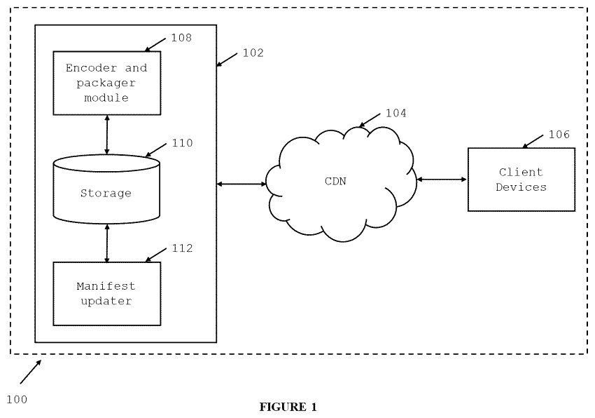

FIG. 1 is a block diagram illustrating a system (100) for embedding custom metadata within streaming manifests in accordance with an embodiment of the present invention. The system comprises a server (102), a Content Delivery Network (CDN) (104) and one or more client devices (106). The server (102) further comprises an encoder and packager module (108), a storage (110) and a manifest updater (112). Hereinafter, in the context of the present invention, the one or more client devices (106) may also be referred to as the client device (106) or client devices (106) without deviating from the scope of the present invention.

The encoder and packager module (108) is configured to generate Adaptive Bitrate (ABR) segments and corresponding media manifests for OTT streaming. In various embodiments of the present invention, the encoder and packager module (108) encodes media content at multiple bitrates to enable adaptive streaming allowing the one or more client devices (106) to dynamically switch between different quality levels based on their available bandwidth and network conditions. For example, a live sports event may be encoded at 720p, 1080p, and 4K resolutions, allowing users on slower networks to receive lower-quality streams while users on faster connections stream higher-quality video. In embodiments of the present invention, the media content may comprise, without any limitation, audio and video data. Further, the encoder and packager module (108) may support multiple codecs such as, without any limitation, H.264, H.265, VP9, and AV1 for video, and AAC, Opus, or AC-3 for audio, ensuring compatibility with a wide range of client devices (106).

Upon encoding the media content, the encoder and packager module (108) may create media manifests that describe the encoded ABR segments. In an embodiment of the present invention, the media manifests may be formatted according to the Dynamic Adaptive Streaming over Hypertext Transfer Protocol (DASH) protocol, specifically as a Media Presentation Description (MPD) file. In another embodiment of the present invention, the media manifests may be formatted according to the Hypertext Transfer Protocol Live Streaming (HLS) protocol, specifically as an M3U8 playlist. To a person of skilled in the art, it may be apparent that the manifest lists the locations of the ABR segments and includes essential information for the one more client devices (106) to retrieve and play back the media content.

The storage (110) is configured to store the generated ABR segments and media manifests and acts as a centralized repository for the encoded content and its associated metadata. In embodiments of the present invention, the storage (110) may be implemented using a cloud-based repository or a local storage system, providing flexible and scalable storage solutions for both live and on-demand streaming scenarios. The storage (110) may maintain an organized hierarchical structure, categorizing each media segment and manifest by content title, quality level, and type (e.g., manifests, video segments, audio segments). This may enable the server (102) to quickly retrieve and deliver the appropriate media content when requested for further processing or delivery. In embodiments of the present invention, for live streaming, the storage (110) may employ a rolling window mechanism that may automatically purge older segments to maintain a fixed time window of available content, ensuring efficient memory usage. In Video on Demand (VOD) scenarios, the storage (110) may retain the complete set of segments indefinitely, enabling client devices (106) to access the media content at any time.

Further, the storage (110) may be optimized for scalability to handle a large volume of media content across multiple titles, formats, and quality levels. It may allow for real-time updates or replacements of manifests as new metadata or content-specific information becomes available. Additionally, the storage (110) may support versioning for manifests, which may enable a quick rollback in case of errors or updates to the metadata, ensuring seamless playback for the end-user. The storage (110) may also incorporate content-aware storage optimization, such as deduplication for segments that are identical across different quality levels, which may help conserve storage space.

The manifest updater (112) is configured to read the generated and encoded manifest from the storage (110) and embed custom metadata for various purposes, including but not limited to content advisories, scene-specific annotations, in-scene advertisements, and user-specific content settings. The custom metadata may be sourced from various internal and external systems and may include diverse types of information depending on the nature of the content and the user engagement required. In an exemplary embodiment of the present invention, the custom metadata may be embedded to inform viewers of sensitive content, such as violence, language, or substance use. For example, if a video contains a tobacco scene, the custom metadata may alert viewers before the scene begins, allowing them to make informed decisions. This custom metadata may be embedded at the relevant points in the manifest and may be automatically triggered when the content reaches the specific segment that requires the advisory. In another exemplary embodiment of the present invention, the custom metadata may be used to insert interactive advertisements within the media. For example, in a cooking show, the custom metadata may trigger an advertisement for kitchen appliances that are being used in the show, providing the viewer with a clickable link to purchase the product. These custom metadata elements may be embedded at appropriate timestamps, ensuring seamless integration within the flow of the video content. In yet another exemplary embodiment of the present invention, the custom metadata may be personalized based on the viewer's profile, geographic location, or playback history. For instance, regional regulations may require different content advisories for different audiences. In one scenario, users from a particular region might receive an anti-tobacco advisory, while others might not, depending on local laws. The manifest updater (112) may ensure that the custom metadata is adjusted to deliver a customized experience for each viewer, based on pre-configured rules or real-time factors. In yet another exemplary embodiment of the present invention, the custom metadata may enhance user engagement by embedding interactive elements directly into the manifest. These interactive elements may include clickable links, pop-up descriptions, or detailed product information. For instance, a video scene showcasing a product may display a tooltip or an overlay with more information about the product, and a link that directs the viewer to a webpage for purchase or further details.

In an embodiment of the present invention, the manifest updater (112) may be configured to dynamically adjust the embedded custom metadata based on evolving content or external factors. For example, in certain regions, regulations might change, necessitating updates to advisories or in-scene advertisements. The manifest updater (112) may accommodate these changes without requiring a full regeneration of the manifest, ensuring both scalability and flexibility.

In an embodiment, the manifest updater (112) may embed the custom metadata as a new Extensible Markup Language (XML) element in the DASH MPD file. The embedded XML element may contain relevant information that may be parsed by compliant streaming client devices (106) to display additional information or interactive content to the user associated with the client device (106). In another embodiment of the present invention, the manifest updater (112) may embed metadata as a custom 8-bit Unicode Transformation Format (UTF-8) tag in the HLS M3U8 playlist. Further in an embodiment of the present invention, the manifest updater (112) may encode the custom metadata in in DASH MPD files and HLS M3U8 playlists by employing base64-encoded JavaScript Object Notation (JSON) format.

In an embodiment of the present invention, the embedding of custom metadata within existing manifest structures using standard-compliant elements i.e., XML for DASH MPD files and UTF-8 tags for HLS M3U8 playlists enables backward compatibility. It may be apparent to a person skilled in the art that backward compatibility may refer to the ability of newer systems to support older or legacy systems without requiring updates or modifications to those older systems. The manifest updater (112) ensures this backward compatibility by structuring the metadata in a way that non-compliant or legacy client devices (106) may process the manifest files without disruption. These client devices (106) are thus enabled to ignore unrecognized elements or tags, allowing for normal content playback without interruption. This approach facilitates the deployment of enhanced features through custom metadata without necessitating modifications to existing playback software or infrastructure, while simultaneously ensuring that client devices (106) that are older may continue to function as intended with the updated content streams.

The CDN (104) serves as the distribution layer for the streaming content to delivering manifest files and media segments to the one or more client devices (106). The CDN (104) may comprise geographically distributed edge servers that cache content close to the one or more client devices (106), reducing latency and improving playback performance. The CDN (104) may implement known in art routing algorithms to direct requests from the one or more client devices (106) to the optimal edge server based on factors like network conditions, server load, and content availability. The CDN (104) may support various streaming protocols, including DASH and HLS, handling each protocol's specific manifest file structure and segment delivery. Further, the CDN (104) may regularly sync with the storage (110) to ensure it has the latest content and updated manifest files. The CDN (104) may also implement cache control mechanisms to manage content freshness for ensuring that any updated manifest files with embedded custom metadata are promptly delivered to the one or more client devices (106). The CDN (104) may allow for seamless content delivery without requiring frequent interaction with the server (102), enabling on-demand streaming with minimal latency.

The one or more client devices (106) are configured to interface with the respective end-user and manage the reception and playback of the streaming content. The client device (106) may support multiple streaming protocols, including but not limited to, DASH and HLS. The client device (106) may also incorporate ABR capabilities, dynamically adjusting the streaming quality based on real-time network conditions. This may ensure optimal playback performance, even in environments with fluctuating bandwidth, by selecting the most appropriate media segment from a range of available quality levels.

Upon receiving a manifest file (DASH MPD or HLS M3U8 playlist), the client device (106) may parse the manifest to extract both standard playback information and any embedded custom metadata. The client device (106) may be capable of identifying protocol-specific metadata embedded in the manifest file, such as XML elements in DASH MPDs or UTF-8 tags in HLS M3U8 playlists. This custom metadata may then be decoded and processed to enhance the user's streaming experience. For example, content advisories, in-scene advertisements, and interactive elements such as clickable links may be rendered based on the decoded metadata. This custom metadata may also be used to control personalized content delivery, such as offering targeted advertisements based on user preferences or adjusting playback settings according to real-time analytics.

In an embodiment of the present invention, where the client device (106) may recognize and processes the embedded custom metadata, the client device (106) may be capable of executing several enhanced playback functions. These functions may include displaying content advisories before specific scenes, inserting advertisements at predetermined points, or presenting supplementary information alongside the main content. In other cases, interactive elements could be displayed, allowing users to engage with the content by accessing additional information, such as product details or clickable pop-ups.

In another embodiment of the present invention, where the client device (106) does not recognize or process the custom metadata, backward compatibility is maintained. The client device (106) continues to play the streaming content without interruption, ignoring any unrecognized metadata elements. This may ensure seamless playback on legacy or non-compliant devices, allowing for consistent delivery of content across different platforms without requiring modifications to the playback software or firmware associated with the client device (106).

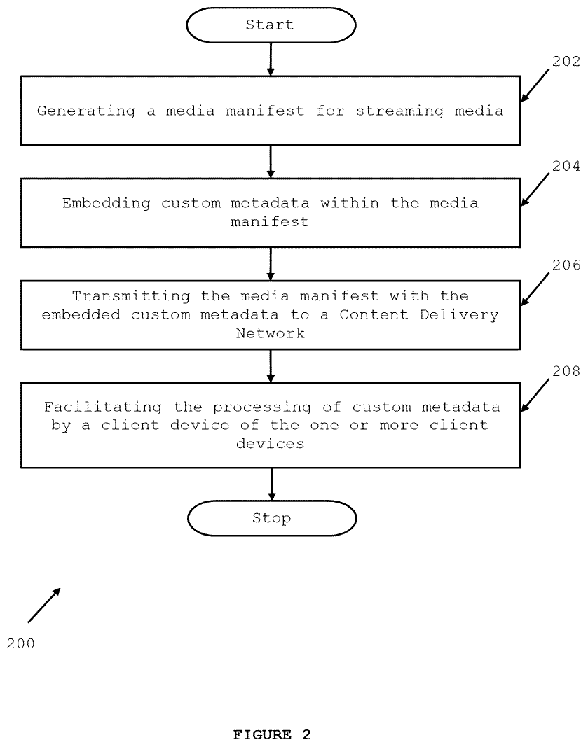

FIG. 2 is a flowchart illustrating a method (200) for embedding custom metadata within streaming manifests in accordance with an embodiment of the present invention. The method facilitates the delivery of additional playback control information embedded in the media manifest, which may be transmitted through a CDN and processed by a client device. This enables enhanced playback functionality without disrupting the streaming experience on the client devices that may not fully recognize the custom metadata.

The method begins at step 202 with the generation of a media manifest for streaming media. The media manifest may serve as an essential component for OTT streaming, containing detailed instructions for the one or more client devices to retrieve one or more media segments associated with the requested media content. These media manifests may typically be generated by a server after encoding the media into multiple quality levels to support ABR streaming. The ABR protocol may allow the one or more client devices to dynamically select the appropriate quality level for the media segments based on factors such as available bandwidth, device performance, and network stability. By incorporating ABR streaming, the one or more client devices may receive the best possible playback quality without buffering or interruptions. Further, the media manifest may include data such as the location of media segments and their corresponding attributes, allowing the one or more client devices to dynamically select the appropriate segments based on network conditions and device capabilities.

At step 204, the custom metadata is embedded within the media manifest. The custom metadata is designed to provide additional playback control information, such as content advisories, scene-specific annotations, and other interactive or personalized elements. The custom metadata may include, but is not limited to, content advisories, scene-specific annotations, in-scene advertisements, and interactive elements such as clickable links or pop-up descriptions. In one embodiment, content advisories could be triggered at specific timestamps to alert the viewer about sensitive content, such as scenes of violence or substance use. In another embodiment, the metadata could be used to deliver personalized advertisements based on user profiles or geographic locations, thereby enhancing viewer engagement. In embodiments of the present invention, for DASH protocol, the custom metadata may be embedded as a new XML element in the MPD file, while for HLS protocol, the metadata may be embedded as a custom UTF-8 tag within the M3U8 playlist. In both cases, the custom metadata may be encoded in base64-encoded JSON format to allow for flexible, extensible and standardized data encoding across different platforms.

At step 206, the media manifest along with the corresponding media segments is transmitted to the CDN. The CDN may be configured for efficiently distributing the media content to one or more client devices by caching and delivering the manifest and media segments from edge servers that are geographically closer to the end users associated with the one or more client devices. This CDN helps reduce latency and ensures faster access to the media content. The CDN may continuously sync with the server to ensure that the latest manifests and media segments are available for delivery, ensuring up-to-date and consistent content for the client devices.

At step 208, the one or more client devices process the custom metadata. The client device receives the media manifest via the CDN, parses the manifest, and extracts both the standard playback information and the embedded custom metadata. In the event that the client device recognizes and supports the custom metadata, it may execute several enhanced playback functions based on the metadata. For example, the client device may display content advisories, insert interactive advertisements, or present supplementary information alongside the media content. The custom metadata may also control user-specific content settings, such as modifying playback parameters based on user preferences or geographical regulations.

In scenarios where the client device does not recognize or process the custom metadata, the method 200 ensures that backward compatibility is maintained. The client device continues to play the media content without interruption by ignoring the unrecognized metadata elements. This ensures that the media manifest may be deployed across a wide variety of devices, including legacy systems that may not support the newer metadata formats. The media content will still be delivered and played as intended, ensuring a seamless user experience across diverse devices and platforms.

Further, the present invention may be implemented within an exemplary OTT streaming system configured to efficiently generate and deliver customized streaming manifests with embedded metadata. At the core of this OTT streaming system, a dynamic processor is provided, which may manifest as a high-performance microprocessor, a specialized streaming processing unit, a micro-controller, a peripheral integrated circuit element, or a combination of these devices, all optimized to handle the generation of ABR segments, creation of media manifests, and embedding of custom metadata for adaptive streaming.

Along with the processor, a versatile memory component is included, which may range from RAM, cache memory, to more advanced memory structures like DDR SDRAM or HBM (High Bandwidth Memory). This memory component is essential, ensuring the immediate availability of media segments, manifest templates, custom metadata, adaptive streaming instructions, and other essential data to the processor for seamless real-time manifest generation and updates.

The OTT streaming system may also comprise advanced communication channels. These channels are designed for high-throughput manifest and media segment exchange across various mediums, such as wired connections like Ethernet or optical fiber, or wireless technologies such as Wi-Fi, 5G, or satellite communications. The OTT streaming system's adaptability ensures compatibility with a spectrum of communication technologies, from high-speed electrical transmissions to the CDN interfaces, facilitating efficient distribution of manifests and media segments.

Additionally, the OTT streaming system may be provided with diverse storage units adept at maintaining vast media content databases and manifest repositories. These units may take the form of magnetic disks, SSDs, NVMe drives, object storage systems, or even distributed cloud storage solutions. The storage units may serve not just as repositories for media segments and manifests, but may also potentially store the program instructions, metadata generation engines, and databases fundamental to the real-time customization and embedding of metadata within manifests as described in the present invention.

The OTT streaming system's architecture is flexible, capable of operating both independently or as part of a broader streaming network, be it a localized content delivery system or an expansive global CDN. It may take the form of a dedicated streaming server, a cloud-based manifest generation platform, or a distributable software package accessible across varied distribution channels and formats, ensuring the seamless integration of custom metadata within streaming manifests for enhanced user experiences across diverse client devices.

Thus, the present invention effectively addresses the outlined technical problems by providing a robust system and method for embedding and managing custom metadata within OTT streaming manifests. One of the primary technical challenges identified was the inconsistent integration of metadata across different platforms and devices. The present invention overcomes this challenge by embedding metadata in a standardized manner, utilizing compliant elements such as XML for DASH manifests and UTF-8 tags for HLS manifests. This ensures uniform processing of metadata across various client devices and platforms, thereby enabling consistent playback experiences, regardless of the device or protocol being used.

Additionally, the present invention resolves the rigidity of traditional metadata integration methods by decoupling the metadata from the media content itself. By embedding metadata within the media manifest, the present invention provides a flexible mechanism that allows real-time updates and adjustments to the metadata without requiring the regeneration of entire content manifests. This dynamic update capability ensures that content and metadata remain synchronized, even when the metadata is updated or modified, thus addressing the desynchronization issues commonly faced in existing systems.

Another significant technical solution provided by the present invention is its ability to ensure backward compatibility. The manifest updater (112) is specifically configured to structure custom metadata in such a way that non-compliant or legacy client devices can ignore unrecognized elements or tags, allowing for normal content playback without interruption. This ensures that newer metadata features do not interfere with the streaming experience on older devices, which may not support the latest metadata standards. As a result, the present invention provides a seamless user experience across a wide range of devices, while simultaneously enabling the introduction of metadata-driven features.

Furthermore, the present invention improvises the overall scalability and efficiency of OTT streaming platforms. By integrating metadata within the manifest, the system reduces latency and improves the speed at which metadata-driven features, such as content advisories and in-scene advertisements, can be deployed. This ensures that streaming platforms can dynamically respond to user preferences, regulatory requirements, and real-time events, thus providing a more interactive and engaging user experience. The use of a content-aware storage system and versioning for manifests also ensures efficient content management, allowing platforms to roll back to previous metadata versions, if necessary, without disrupting the streaming process.

The above detailed description has been provided to enable a person skilled in the art to implement and practice the present invention. It will be readily apparent to those skilled in the art that various modifications, changes, and improvements can be made to the disclosed embodiments without departing from the spirit or scope of the invention. The principles and features described herein are applicable to a wide range of alternative configurations, and certain aspects of the invention may be employed independently of others. Therefore, the present invention is not intended to be limited to the specific embodiments shown and described but should be given the broadest possible interpretation consistent with the underlying principles and novel features disclosed.

I/We claim:

1. A system (100) for embedding custom metadata in Over-The-Top (OTT) streaming manifests, the system comprising:
an encoder and packager module (108) configured to generate Adaptive Bitrate (ABR) segments and corresponding media manifests for streaming media, the media manifest including instructions for retrieving one or more media segments associated with the streaming media;
a manifest updater (112) configured to embed custom metadata within the media manifest, the custom metadata being configured to provide additional playback control information;
a storage (110) configured to store the generated ABR segments and media manifests with embedded custom metadata;
a Content Delivery Network (CDN) (104) configured to deliver the media manifest and the associated ABR segments to one or more client devices (106); wherein the one or more client devices (106) are configured to process the custom metadata to enhance the streaming experience, and wherein the one or more client devices (106) are operable to continue playback of the streaming media without processing the embedded custom metadata.

2. The system as claimed in claim 1, wherein the encoder and packager module (108) is configured to generate the media manifest in accordance with at least one of: Dynamic Adaptive Streaming over Hypertext Transfer Protocol (DASH) protocol and Hypertext Transfer Protocol Live Streaming (HLS) protocol.

3. The system as claimed in claim 2, wherein the manifest updater (112) embeds the custom metadata as a new Extensible Markup Language (XML) element in a Media Presentation Description (MPD) file for the DASH protocol.

4. The system as claimed in claim 2, wherein the manifest updater (112) embeds the custom metadata as a custom 8-bit Unicode Transformation Format (UTF-8) tag in an M3U8 playlist for the HLS protocol.

5. The system as claimed in claim 1, wherein the custom metadata is encoded in a base64-encoded JavaScript Object Notation (JSON) format to facilitate flexible, extensible and compact representation of metadata fields.

6. The system as claimed in claim 1, wherein the media manifest is transmitted through an adaptive bitrate streaming protocol to optimize playback quality based on real-time network conditions.

7. The system as claimed in claim 1, wherein the custom metadata comprises information for controlling playback features, including one or more of: content advisories, scene-specific annotations, in-scene advertisements, user-specific content settings, and interactive elements.

8. A method for embedding custom metadata in OTT streaming manifests, the method comprising:
generating a media manifest for streaming media, the media manifest including instructions for retrieving one or more media segments associated with the streaming media;
embedding custom metadata within the media manifest, the custom metadata configured to provide additional playback control information;
transmitting the media manifest with the embedded custom metadata to a Content Delivery Network (CDN), wherein the CDN is configured to deliver the media manifest to one or more client devices;
facilitating the processing of custom metadata by a client device of the one or more client devices to enhance the streaming experience, wherein the client device is operable to continue playback of the streaming media without processing the embedded custom metadata.

9. The method as claimed in claim 8, wherein the streaming media is at least one of: Dynamic Adaptive Streaming over HTTP (DASH) protocol and HTTP Live Streaming (HLS) protocol.

10. The method as claimed in claim 9, wherein for the DASH protocol, the custom metadata is embedded as a new XML element in a Media Presentation Description (MPD) file.

11. The method as claimed in claim 9, wherein for the HLS protocol, the custom metadata is embedded as a custom UTF-8 tag in an M3U8 playlist.

12. The method as claimed in claim 8, wherein the custom metadata is encoded in base64-encoded JSON format.

13. The method as claimed in claim 8, wherein the media manifest is transmitted via an adaptive bitrate streaming protocol to optimize playback quality based on network conditions.

14. The method as claimed in claim 8, wherein the custom metadata comprises information for controlling playback features, including one or more of: content advisories, scene-specific annotations, in-scene advertisements, user-specific content settings, and interactive elements.
